(19) United States
(12) Patent Application Publication
(10) Pub. No.: US 2002/0082869 A1
(43) Pub. Date: Jun. 27, 2002

(54) Method and system for providing and updating customized health care information based on an individual's genome

(75) Inventor: Glen J. Anderson, Sioux City, IA (US)

Correspondence Address: LYON & LYON LLP, 633 WEST FIFTH STREET, SUITE 4700, LOS ANGELES, CA, 90071, US

(73) Assignee: Gateway, Inc.

(21) Appl. No.: 09/751,890

(22) Filed: Dec. 27, 2000

(51) Int. Cl. G06F 17/60

(52) U.S. Cl. 705/3; 705/2

(57) ABSTRACT

A method for providing and updating customized health care based, at least in part, on the genome of an individual is provided, wherein the genome is extracted from a biological sample of the individual. The method comprises the following steps: sequencing the genome into its DNA sequence; interpreting the DNA sequence to identify medical conditions or diseases associated with the genome; archiving the conditions or diseases in a storage device; informing the individual of the conditions or diseases for which he or she has genetically tested positive; tracking health and medical information related to the conditions or diseases; and providing this information to the individual. Preferably, this method is implemented electronically. A server receives certain data items, e.g., the individual's DNA sequence, associated conditions or diseases and related health and medical information, and archives at least one of these data items. The server periodically tracks this information over the Internet, and electronically provides to the individual the conditions or diseases for which he or she has genetically tested positive, as well as information related to these conditions or diseases.

### FIELD OF THE INVENTION

The present invention generally relates to the application of human genomics, the study of human genes and their functions, to providing health care measures and solutions. In particular, the present invention relates to a method and system for providing and updating customized health care information to an individual based, at least in part, on the genetic blueprint provided by that individual's genome.

### BACKGROUND OF THE INVENTION

A large part of the diversity of the world's over six billion people can be accounted for by the set of genetic instructions in each person's genome. The differences between two unrelated individuals, however, may reflect only minor variations in the genetic instructions of each—e.g., one variation out of five hundred similarities. These genetic instructions are carried out and translated into human traits and characteristics via the activities and interactions of approximately 100,000 kinds of protein molecules coded for and produced by every human genome. Proteins provide the structural components of cells and tissues as well as enzymes for essential biochemical reactions. Thus, the machinery of every human mind and body is built and run with the protein molecules that are constructed by the human genome.

The human genome consists of threads of deoxyribose nucleic acid (DNA) organized into 24 distinct, physically separate units called chromosomes. DNA consists of two strands that wrap around each other to resemble a twisted ladder whose sides, made of sugar and phosphate molecules, are connected by rungs of nitrogen-containing chemicals called bases. Four different types of bases are present in DNA: adenine (A), thymine (T), cytosine (C) and guanine (G), and the particular order of these bases arranged along the sugar-phosphate backbone is called the DNA sequence. The two DNA strands are held together by weak links, called base pairs, between specific, complementary bases, i.e., A pairs with T, C pairs with G.

The human genome contains an estimated 100,000 genes, which are specific sequences of base pairs that direct the synthesis of proteins. Proteins are made up of long chains of subunits called amino acids, of which there are about twenty different types. Each specific sequence of three DNA bases, called a codon, directs the cells' protein-synthesizing machinery to add a specific amino acid. For instance, the sequence AAU dictates that the amino acid asparagine should be added to the protein chain. GCA corresponds uniquely to alanine, etc. Thus, human genes are each a series of base sequences that specify which amino acids are required to make up specific proteins.

Not only do these genes, via the protein molecules for which they code, determine physical characteristics such as eye color and hair color, but they play a major role in determining virtually all human afflictions, from cancer to psychiatric disorders to adverse responses to drugs. While the precise sequence of A, C, G, and T bases on a DNA strand encodes the exact structure of a protein, sequences that have extra or deleted bases, or bases that are out of order, may produce the wrong protein or too much or too little of the right one. These mistakes in protein production may result in biochemical errors and, consequently, disease and/or atypical bodily responses to foreign substances such as bacterial or viral infections or pharmaceutical drugs. Errors in our genes are responsible for an estimated 3,000-4,000 hereditary diseases, including sickle cell anemia, Huntington's disease, cystic fibrosis, and Duchenne muscular dystrophy. Many of these diseases are caused by the variation of a single nucleotide base, known as single nucleotide polymorphism (SNP's), in a DNA sequence that codes for a particular protein. Further interpretation of DNA sequences to identify even more SNP's or other genetic variations associated with physical and medical conditions and diseases underlines the Human Genome Project (HGP)—the international effort to “map” out the sequence of the 3 billion base pairs that make up the human genome.

In June of 2000, the HGP announced the initial sequencing of approximately 90% of the human genome, and its further goals to discover all of the human genes and make them accessible for further study. Sequencing is only the first step in fully deciphering the human genome, however. These sequences have to be translated into discrete protein-coding genes. For instance, further research will better determine where genes begin and end and recognize non-coding DNA sequences, such as regulatory sequences that start or stop the construction if a protein. The specific functions of these genes, and the role of the proteins for which they code must be better understood, and correlated with genetic linkage data, disease gene research and other available genetic information to identify at a molecular level the conditions and diseases with which they are associated.

Many companies are providing HGP researchers with databases and online services that allow them to share resources and collaborate with colleagues worldwide to identify specific genes and their functions. For instance, Celera Genomics Corporation has facilitated and expedited the Project's sequencing efforts by using automated sequencing technologies and creating a database of all the identified sequences. This database is accessible over the Internet and intended primarily for biotech and academic scientists to conduct gene discovery and do genetic experiments online. As another example, Doubletwist has a database with more than 2 billion base pairs as well as information about identified sequences and functions of individual genes.

Arguably, one of the most valuable objectives in understanding the complete genetic blueprint of individuals, however, is practical: translating this blueprint into novel healthcare strategies and therapies. Each individual's unique DNA sequence can yield information that would optimize health care as well as quality of life. This information, for instance, would alert individuals about the conditions and diseases for which they are at risk, predict the course of disease, guide the development of drugs therapies based on the molecular understanding of how diseases are caused, and ensure the most effective preventive measures and treatment. Gathering, tracking and providing this information to the public is crucial to allow both healthy and afflicted individuals to make educated choices about lifestyle and medical treatment.

Only very few companies, however, have developed genetics-related services that address health care solutions or are even directed to the public generally. For instance, Orchid BioScience plans to introduce a service whereby a person can send cells from a body sample, such as those scraped from the inside of his or her cheek, to a lab for DNA analysis. Once the analysis is complete, the subjects will be able to check over the Internet whether they are genetically predisposed to any adverse drug reactions. Kiva, Inc. aims to analyze the genotypes of large numbers of people to correlate the relationship between genetic variation and common diseases like diabetes and cancer. Participants in the program may track the progress of studies online, but Kiva stops short from giving away detailed genetic data that could reveal whether they have a predisposition to disease.

Thus, what is needed is a method and system that takes advantage of the findings of the HGP, as well as available resources and technologies to sequence and interpret genomes, to provide health care solutions to the public.

### SUMMARY

The present invention relates to a method and system for providing and updating customized health care to an individual based, at least in part, on the genome of that individual. This invention requires that the individual provide a biological sample, such as a blood sample, to a lab so that his or her genome may be extracted from the cells of the biological sample.

The method comprises the following steps: sequencing the genome of an individual into its DNA sequence; interpreting this DNA sequence; searching for physical and medical conditions and diseases associated with the individual's genetic blueprint; archiving information relating to the existence of these conditions and diseases in a storage device, such as a secured computer database; making this information available to the individual; tracking for additional health and medical information related to these conditions and diseases, and making this tracked information available to the individual. Preferably, the steps of the method are implemented electronically over a computer network. However, the steps of informing the individual of pre-dispositions to and/or existing conditions and diseases and providing relevant health and medical information to the individual may be done in person, by mail or over the telephone. Moreover, tracking related health and medical information is preferably implemented by a software program that periodically scours the Internet, although it could also be done manually by researchers.

In one preferred embodiment, the step of searching for conditions and diseases associated with the individual's DNA sequence is updated as more genetic variations associated with conditions and diseases are discovered. Researchers could keep up to date with such discoveries. Preferably, a program tracks such new discoveries over the Internet. In either case, the individual would be informed of these discoveries so that he or she could elect whether to update the interpretation of his or her DNA. Such tracking and communicating takes advantage of the ever-growing body of genetic information.

In another embodiment, the step of tracking information related to the individual's conditions and diseases includes communicating with health and medical specialists so that they may provide their own recommendations and refer their own resources of health and medical information to the individual.

In yet another embodiment, health and medical specialists review the tracked health and medical information and provide their own analyses of such information, preferably based on all archived data related to that individual, such as the conditions and diseases for which the individual genetically tested and any personal data provided by the individual. Analyses include, for instance, recommendations and counseling relating to the tracked health and medical information.

Preferably, this method also includes having the individual or, for instance, the individual's physician, provide personal data, such as the individual's age, gender, medical history, and age and medical history of that individual's relatives, and adjusting the step of tracking to additionally search and retrieve health and medical information related to this personal data.

This and further objects and advantages will be apparent to those skilled in the art in connection with the drawings and the detailed description of the preferred embodiments set forth below.

### BRIEF DESCRIPTION OF THE DRAWINGS

FIG. 1 is a block diagram showing a preferred embodiment of the method of the present invention.

FIG. 2 is a block diagram showing a preferred embodiment of the system of the present invention.

### DETAILED DESCRIPTION OF THE EMBODIMENTS

The present invention relates to a method and system for providing and updating customized health care information to an individual based on the genome of that individual.

The method 10 begins with having an individual 12 submit a biological sample 14, such as his or her blood, to a lab to extract genome 16 from the cells of biological sample 14. In step 18, the genome 16 of an individual 12 is sequenced. Sequencing refers to determining the DNA sequence 20 of that individual—i.e., the specific order of nucleotide base pairs in the individual's genome. Sequencing may be accomplished by any one of many well-known techniques that use recombinant DNA and cloning procedures, including gel electrophoresis, primer walking, use of transposons, sample sequencing, and “shotgun” sequencing, or any other sequencing technique. One preferred embodiment would employ the “shotgun” sequencing approach because it employs computerized processes in analyzing sequenced DNA fragments taken from the genome of interest. In shotgun sequencing, many copies of a single large clone are broken into pieces of approximately 1500 base pairs. Each fragment is then separately cloned, and a convenient portion of it is sequenced. A computerized, computational assembly process then compares the sequences at the ends of each fragment and, by finding overlaps that indicate neighboring fragments, constructs an ordered library for the parent clone. Preferably, DNA sequence 20 is archived in a storage device 34, which is preferably a computer database capable of archiving large quantities of data in a secure environment. This secure environment could be created by using any standard security scheme or technology, for instance, by requiring individual 12 to choose confidential identification information, such as a password, and condition access to the archived DNA sequence 20 upon input of such identification information.

Next, in step 22, the DNA sequence 20 is interpreted to identify any genetic variations associated with genome 16. Then, step 23 comprises searching for conditions 24 associated with DNA sequence 20 and, in particular, with any genetic variations identified by interpretation 22.

Condition as used herein refers to any single deviation from, or interruption of, the normal structure or function of any part, organ or system of the body, as well as any set of such deviations that comprise a particular disease. In addition, the “condition” that is genetically coded for could also refer to abnormal susceptibilities to infection or adverse reactions to pharmaceutical drugs. Interpretation 22 and search 23 would be conducted consecutively and, together, would alert a seemingly healthy individual about his or her genetic pre-dispositions to developing certain conditions. Or this information could diagnose an unwitting individual about an existing condition, thereby hopefully advising the individual in time to positively effect the course of the condition.

Interpretation of the DNA sequence 20 could be accomplished in several well-known ways. First, the individual's DNA sequence could be electronically compared against at least one database of “normal” genes not known to be associated with any condition or disease, and then identifying the irregular DNA sequences. In one method of interpretation, the individual's DNA sequence would be input into a computerized system that analyzes the sequence, or at least portions thereof, and compares it to at least one database of specific genetic variations known to be associated with certain physical or medical conditions and/or diseases. Variations of this latter type of system are, for instance, the GRAIL and GenQuest sequence comparison systems.

Searching 23 would compare and match—either manually or electronically via available software programs—genetic variations identified by interpretation 22 with known sequences associated with conditions and/or diseases.

Alternatively, interpretation 22 could be implemented by analyzing biological sample 14 with an array procedure, preferably any one of several DNA microarray technologies, such as the NanoChip available from Nanogen and the GeneChip available from Affymetrix. These technologies involve arrays, or orderly arrangement of DNA probes to match known and unknown DNA sequences based on base-pairing rules. These arrays are placed on microchips so that the process of identifying the unknown sequences being tested is automated. In thiscase, searching 23 would utilize these technologies to analyze DNA samples and determine the presence of target DNA sequences, including SNP's, by testing the samples with cloned probes that mate only with the target sequences. Thus, if individual 12 were concerned about developing cystic fibrosis because of his or her family history, this DNA microarray technology could test genome 16 with a DNA probe cloned to include the sequence of bases that pair with the AF508 mutation associated with cystic fibrosis.

As an example, say that the genome of individual 12 includes 3 deletions in the 27 DNA segments that comprise the gene coding for the protein known as CFTR or cystic fibrosis transmembrane conductance regulator. It is known that these deletions, referred to as the AF508 mutation, lead to the loss of just one amino acid out of the 1,480 in the protein for which the gene codes. Yet this slight change is enough to disrupt the functions of the CTFR protein, which normally serves as a chloride channel and regulates the transfer of sodium across membranes of epithelial cells that line the surfaces, ducts and passageways of organs. If the CFTR protein malfunctions, this process fails and sodium builds up in these ducts and passageways, which become clogged with unusually thick mucus secretions. Impaired organs cannot move substances, such as enzymes and proteins, normally and become more easily infected. These conditions make up the disease of cystic fibrosis. The interpretation step recognizes the AF508 mutation as a gene for cystic fibrosis.

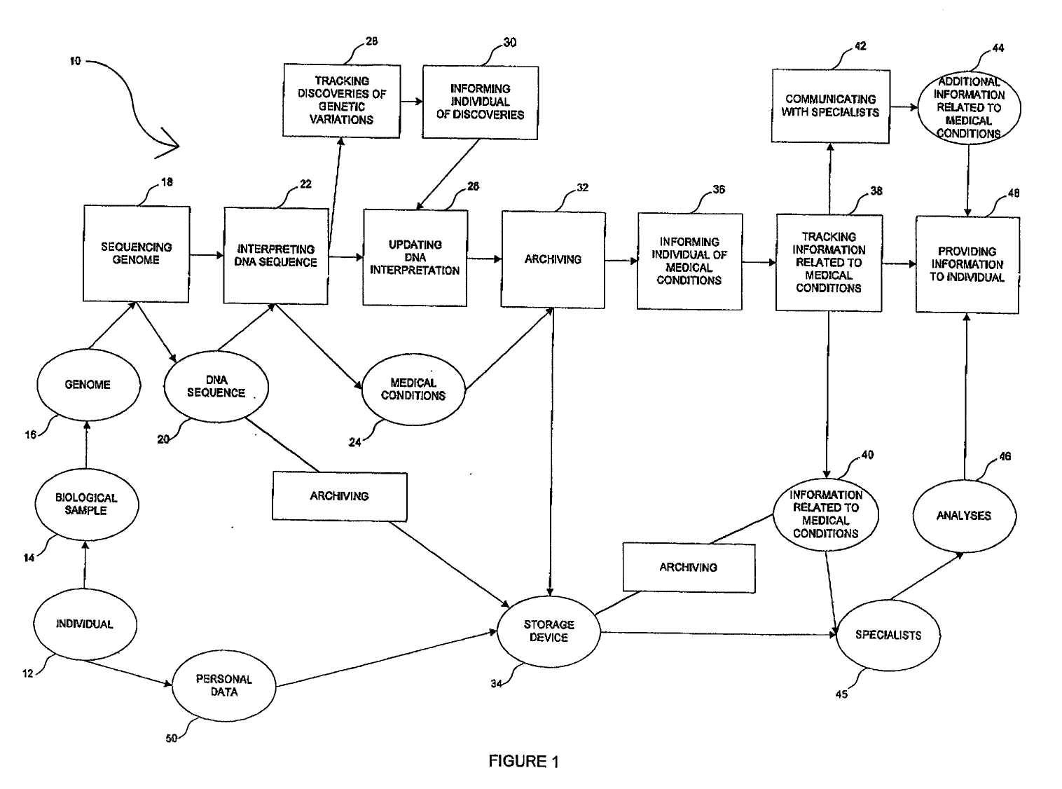

Although genetic variations are currently associated with at least 4,000 different types of conditions and diseases, many more genetic sequences remain to be identified by researchers. Thus, in the preferred embodiment depicted in FIG. 1, searching 23 would be dynamic: i.e., the step is periodically updated as researchers identify and make accessible more specific genetic variations associated with conditions and/or diseases.

In step 26, updating the searching 23 of the DNA sequence 20 could be done whenever individual 12 so requests, or automatically upon the passage of a certain period of time, such as once every six months or once a year. This step preferably includes automatically tracking new discoveries 28 regarding the identification of specific genetic variations associated with additional conditions and diseases. However, the update period may be pre-determined or chosen by the individual 12.

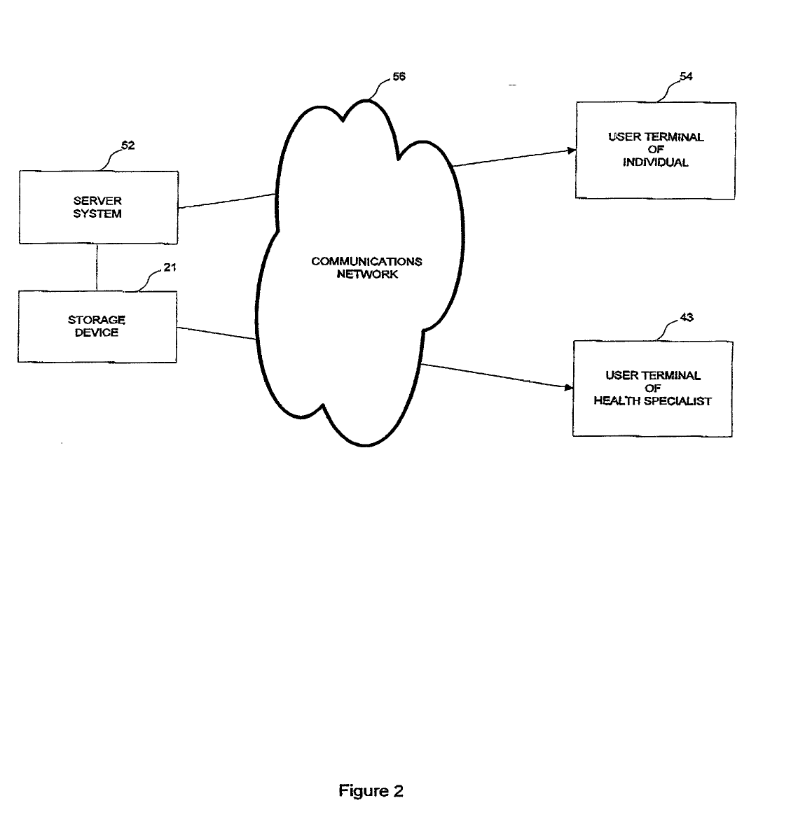

Preferably, new discoveries are tracked electronically, by use of a known software program, such as a “robot” or “spider” that operates with a server 52 (FIG. 2) to search and retrieve relevant information about such discoveries from others' Web sites. The software would only search information that had been published, posted or otherwise made available since the last search, and would retrieve the URL's of the Web pages containing relevant information, or copies of the pages bearing the information. Server 52 would receive the information and transmit it immediately to individual 12 or, preferably, archive it at least temporarily in storage device 21.

To transmit this information to individual 12, sever 52 is connected to a user terminal 54 of at least one individual through a communications network 56 such as the Internet, as depicted in FIG. 2. The user terminal may comprise, by way of example and not limitation, a personal computer, internet appliance, personal digital assistant, or other information handling system capable of connecting to server 52, receiving data from server 52 and transmitting data to server 52.

Tracking could also be done manually by individual researchers that keep up to date with science magazines, journals, Web sites and other sources of information for these discoveries.

In step 30, the individual 12 is informed of the existence of these new discoveries, so that the individual could elect to have the search of his or her DNA sequence updated in light of the new discoveries. This step would preferably be implemented electronically. For instance, server 52 could post such new discoveries, or information relating thereto, on a Web site that is associated with server 52 and accessible by user terminal 54; provide hypertext links on this Web site to other sites featuring information about such new discoveries; or send electronic mail messages to user terminal 54 regarding such new discoveries. Finally, in this preferred embodiment, server 52 would make DNA sequence 20 available from storage device 21 for further searching and analysis upon the election of individual 12.

It is understood that privacy and confidentiality of such information is of utmost concern. Accordingly, it is further understood that the present invention can also be practiced in a “blind” security arrangement, whereby the user anonymously submits a biological sample 14 having an identifier, such as a serial number. Then, all future contact can occur via a service provider's web site, wherein any individual can review information on any sample 14, but only the submittor of a specifically identified sample will know that the information pertains to him or her. In this way, undesired uses of such sensitive information can be prevented. While this requires the individual 12 to be more proactive, since an update email cannot be sent to an anonymous submittor, this will protect the privacy of the individual to a greater degree. Other security and privacy measures are also contemplated. For example, an individual may set up an anonymous email account on a web based email service, such that relevant information can be sent from a service provider to the individual's 12 anonymous email account, without the service provider having any personal information on the particular individual 12.

Next, in step 32 information 33 relating to the conditions 24 of individual 12 discovered in step 23 or step 26 are archived. Implementation of this step involves use of storage device 21, which, as described above, preferably comprises a secured computer database. For instance, in one embodiment, the individual's DNA sequence 20 and conditions 24 are assigned to the same confidential user identification information and archived in storage device 21, so that either would be exclusively accessible upon input of this identification information. Information 33 comprises the existence of conditions 24, or the pre-disposition to developing conditions 24. Preferably, however, it also includes measures for the prevention, diagnosis, evaluation and treatment of conditions 24, as described in more detail below.

In step 36, the information 33 is made available to individual 12. This step may be implemented by any secure means, such as a phone call or a face-to-face meeting. Other preferable means include providing user terminal 54 of individual 12 electronic access to secured storage device 21, or, alternatively, by electronically relaying conditions and diseases 24 to user terminal 54 through electronic, encrypted files or messages.

Next, in step 38, additional health and medical information 40 relating to the individual's pre-dispositions to and/or existing conditions 24 is tracked. Additional information 40, and preferablt information 33 as well, comprise, among other things, measures that the individual could implement for the prevention, diagnosis, evaluation and treatment of conditions 24. Examples of such measures include recommended diet, including what foods to eat and what foods to avoid, recommended caloric intake, suggested levels of carbohydrates, fats proteins and the like, and vitamin supplements. The measures could also be directed to recommended exercises or fitness regimens, including suggested type and frequency of work-outs. Recommendations regarding physicians' visits, including the type of specialists to see, the name of recommended specialists in the area, and the frequency of visits, could be provided. Likewise, suggestions could also be directed to proposed medical tests and/or assays to better diagnose the extent of a condition and/or disease or evaluate its prognosis. Moreover, information about the individual's response to drugs and other forms of treatment could be gathered.

For example, additional information 40 and/information 33 pertinent to the disease of cystic fibrosis would include recommendations about diet because of the thick mucus secretions caused by the disease that keep some foods from being digested and absorbed. In particular, people stricken with CF need to eat more proteins, fats and salt, and to supplement their diet with replacement vitamins that their bodies do not uptake from foods. In addition, information 40 would recommend individual 12 to regularly do cardiovascular exercises to increase the strength of their heart and lungs, and to regularly undergo “chest physical therapy” to dislodge mucus from the lungs. Diagnosis measures would include a test that measures the chloride content in perspiration. Treatment measures would cover antibiotics that control repeated infections, as well as the possibility of gene therapy by delivery of a healthy CFTR gene into epithelial cells of affected organ(s).

A preferred feature of the present method is that this information is not gathered just once, but periodically for as long as individual 12 chooses—even over the course of the individual's lifetime. Tracking 38 can be implemented manually by individuals that research and review relevant information in health, medical and science magazines, journals, Web sites and other information resources. Preferably, however, this information would be tracked by some electronic means, such as use of a “robot” or “spider” software program, that would periodically search relevant Web sites over the Internet for content related to the individual's conditions 24. The frequency at which these searches are executed may be chosen by the individual or pre-programmed. The URL's of the Web pages, or copies of the actual pages themselves, containing additional information 40 would also preferably be archived in storage device 21, at least temporarily, along with the individual's DNA sequence and conditions and/or diseases to facilitate providing that information to the individual.

In one embodiment, tracking 32 could be further implemented by communicating with health and medical specialists 42 in some of the disciplines described above, such as nutritionists, exercise physiologists or personal trainers, medical specialists, medical technicians and the like. In this embodiment, server 52 would be connected to and adapted to communicate with user terminal 43 of at least one health and medical specialist through a communications network such as the Internet. In this way, server 52 could electronically communicate additional information 40 and/or information 33 in an anonymous manner to these specialists, who, in turn, could then provide further health and medical information 44, such as personal recommendations and advice, and/or recent articles or studies, or links to such information, regarding the prevention, diagnosis, evaluation and/or treatment of the individual's conditions and/or diseases. Preferably, this communication would occur electronically, such as over e-mail.

In another embodiment, additional information 40 and/or information 33 are additionally analyzed by health and medical specialists 45, such as those described above, to provide individualized analyses 46 of this information, including recommendations and counseling based thereon. In this embodiment, server 52 could transmit health and medical information to user terminal 43 for analysis by at least one health and medical specialist. Preferably, via this communications network connection between server 52 and user terminals 43, server 52 would recall all the data specific to individual 12 that is archived in storage device 21, i.e., information 33, additional information 40 and any personal data, as discussed below, and display the data to the specialist in an anonymous manner over a Web site associated with server 52, or electronically relay this data to the specialist. Specialists 45 could then review this collection of data, and prepare analyses 46, including recommended measures, based on all the information made available to them and their own expertise.

Finally, in step 48, the information 33 and/or additional information 40 (and, if relevant, additional information 44 and analyses 46) are made available to the individual 12. This step could be implemented by providing the individual electronic access to secured storage device 21. Once individual 12 passes the security layer or technology, such as inputting confidential user identification information, individual 12 will be able to view, peruse and download electronic copies of additional information 40 and/or information 33 from storage device 21 over a Web site, or to hyperlink from this Web site to the Web sites from which this information originates via the URL's stored in database 24. Alternatively, this information could be relayed to user terminal 54 of individual 12 by any secured means, including via electronic mail, at a frequency that is either chosen by the individual or pre-determined. It is understood that, based on the security measures described previously, information 33 and additional information 40 may be made selectively available to the individual.

In another preferred embodiment of the present method, individual 12, or an authorized representative of the individual such as his or her physician, provides personal data 50, including but not limited to the individual's age, birthday, medical history as well as the age and medical history of the individual's relatives. This personal data can be provided at the time the individual submits biological sample 14, or any time thereafter. Personal data 50 is then also archived in database 34 in a secure manner. The step of tracking 38 is adjusted to additionally search for health and medical information related to the personal data. For instance, if personal data 50 sets forth that individual 12 is a woman, aged 24, with a history of breast cancer in her family, the step of tracking would cover health and medical information relating to, for instance, performing self breast exams and undergoing mammograms, even if individual 12 did not test for breast cancer or any pre-disposition thereto. While tracking 38 occurs at some pre-determined frequency, the frequency could also increase at some proportional rate as the individual ages.

While preferred method and system embodiments have been shown and described, it will be apparent to one of ordinary skill in the art that numerous alterations may be made without departing from the spirit or scope of the invention. The invention is not to be limited except in accordance with the following claims and their legal equivalents.

What is claimed is:

1. A method for providing and updating customized health care information to an individual based on the genome of that individual, the genome taken from a biological sample of the individual, comprising:
sequencing said genome into its DNA sequence;
interpreting said DNA sequence;
searching for at least one medical condition associated with said genome;
archiving information relating to the existence of said condition in a storage device;
making information relating to the existence of said at least one medical condition available to said individual;
tracking for additional information relating to said at least one medical condition; and
making said additional information accessible by said individual when available.

2. The method of claim 1 wherein said interpreting comprises comparing said DNA sequence to at least one database of genetic variations associated with said condition.

3. The method of claim 1 further comprising archiving said interpretation of said DNA sequence

4. The method of claim 3 further comprising updating said searching for at least one additional medical condition associated with said DNA sequence.

5. The method of claim 4 wherein said updating comprises tracking discoveries of genetic variations associated with said at least one additional medical condition.

6. The method of claim 5 wherein said tracking is implemented electronically.

7. The method of claim 5 further comprising making information of said discoveries available to the individual.

8. The method of claim 1 further comprising making said interpretation of said DNA sequence accessible for future analysis.

9. The method of claim 8 further comprising analysis of said interpretation of said DNA sequence for at least one additional medical condition associated with said genome after said initial searching step has been completed.

10. The method of claim 1 wherein said information comprises measures for the prevention, diagnosis, evaluation and treatment of said condition.

11. The method of claim 1 wherein said tracking is implemented electronically.

12. The method of claim 1 further comprising archiving said additional information.

13. The method of claim 1 further comprising communicating said information to a health specialist.

14. The method of claim 11 further comprising receiving an analysis of said information from the health specialist.

15. The method of claim 1 wherein said making said information accessible comprises providing the individual electronic access to said information in said storage device.

16. The method of claim 1 further comprising receiving personal data from the individual and archiving said personal data, wherein said tracking is adjusted to additionally retrieve information related to said personal data.

17. A method for providing and updating customized health care information to an individual based on the genome of that individual, the genome taken from a biological sample of the individual, comprising:
sequencing said genome into its DNA sequence;
archiving said DNA sequence;
interpreting said DNA sequence to identify medical conditions associated with said genome;
updating said interpretation of said DNA sequence;
archiving said conditions in a storage device;
informing said individual of said conditions;
tracking information related to said conditions; and
making said information available to said individual.

18. A method for providing and updating customized health care information to an individual based on the genome of that individual, the genome taken from a biological sample of the individual, comprising:
sequencing said genome into its DNA sequence;
interpreting said DNA sequence to identify medical conditions associated with said genome;
informing said individual of said conditions;
archiving said conditions in a storage device;
receiving personal data from said individual;
archiving said personal data;
tracking information related to said conditions;
tracking information related to said personal data; and
making said information available to said individual.
